(19) United States
(12) Patent Application Publication
(10) Pub. No.: US 2010/0005320 A1
(43) Pub. Date: Jan. 7, 2010

(54) Protected Midspan Power Sourcing Equipment for Power Over Ethernet Applications

(76) Inventor: Alan J. Squillante, Kings Park, NY (US)

Correspondence Address: BODNER & O'ROURKE, LLP, 425 BROADHOLLOW ROAD, SUITE 108, MELVILLE, NY, 11747, US

(21) Appl. No.: 11/921,474

(22) PCT Filed: Jun. 2, 2006
(86) PCT No.: PCT/US06/21403

§ 371 Date: Jun. 15, 2009

Related U.S. Application Data
(60) Provisional application No. 60/686,781, filed on Jun. 2, 2005.

(51) Int. Cl. G06F 1/00

(52) U.S. Cl. 713/300

(57) ABSTRACT

A protected midspan power sourcing equipment for a local area network communications system includes a network connection subsystem that is connectable to at least one first network cable having a plurality of electrical wires, and a powered equipment connection subsystem that is connectable to at least one second network cable also having a plurality of electrical wires. The at least one second network cable is commumncatable with a powered end station of the LAN communications system and provides power signals and voice and data signals to the powered end station. A power source is connected to the second network cable and the powered equipment connection subsystem and generates the power signal that is provided on the at least one second network cable to the powered end station. Electrical surge protectors in the midspan power sourcing equipment are connected to the powered equipment connection subsystem and the at least one second network cable and provide electrical surge protection for the powered end station.

### CROSS REFERENCE TO RELATED APPLICATION

This application is related to U.S. Provisional Application Ser. No. 60/686,781, filed on Jun. 2, 2005, and entitled “Protected Power Over Ethernet Midspan”, the disclosure of which is incorporated herein by reference. This application claims the benefit of priority under 35 U.S.C. 119 and/or 35 U.S.C. 120 to the aforementioned related provisional application.

### BACKGROUND OF THE INVENTION

1. Field of the Invention

This invention relates generally to Power Over Ethernet (POE) data and voice communications systems having POE capability, and more particularly relates to protection circuitry for data and voice communications systems that are configured to provide POE signals to nodal equipment on the system.

2. Description of the Prior Art

The Institute of Electrical and Electronic Engineers (IEEE) has adopted a standard that governs the application of Power Over Ethernet (POE). More specifically, IEEE Standard 802(a)(f) defines POE as a system that provides and uses power through local area network (LAN) cabling, thus reducing the need to provide standard electrical outlets to provide power to various nodes within a network. Midspan and endpoint power sourcing equipment (PSE), such as the power supply described in U.S. Pat. No. 6,473,608, which issued to Amir Lehr et al., the disclosure of which is incorporated herein by reference, is defined in the standard as a means to provide power over conventional four-pair category cables. This power is used to operate various powered nodal devices, such as wireless LAN access points, voice-over-internet protocol (VOIP) telephones, network cameras, and the like. Many other powered devices are being developed that will use the power delivered over standard four-pair category cables.

A typical midspan PSE as defined by IEEE Standard 802.3(a)(f)-2003 and shown in a typical link section of a communications network is illustrated by FIG. 1 of the drawings. Conventional LAN cabling having four pairs of twisted copper wires 2 cabled together under a common jacket is connected between the non-PSE hub or other equipment 4 of the LAN system and a midspan PSE 6. Two of the pairs of twisted copper wires 2a, 2b are employed for transmitting data to a node of the network, which is illustrated in FIG. 1 as a powered end station 8 (e.g., a web camera or an IP telephone). Data on these two pairs of copper wires pass 2a, 2b through the midspan PSE 6, unchanged and unprotected, to the powered end station 8 through a second conventional cabling also having four pairs of twisted copper wires 10 cabled together under a common jacket.

The two remaining twisted pairs of wires 2c, 2d in the first cabling are not used. The midspan powered sourcing equipment (PSE) 6 includes a power supply 12, such as that shown in the aforementioned Lehr et al. patent, which provides power and a return on two twisted pairs of copper wires 10a, 10b in the second LAN cabling to the powered end station 8 to which a powered device (PD) 14 of the end station 8 is connected.

Underwriters Laboratories Inc. (UL) of Northbrook, Ill., a well-known independent not-for-profit product safety testing and certification organization, also provides standards that define the over-voltage and over-current protection requirements for communication circuits, in particular, in the UL standards referred to as UL 497, 497A and 497B. Other standards organizations and communication companies also specify requirements for over-voltage and over-current protection. In communications systems, such over-voltage and over-current protection devices are commonly referred to as “surge protectors”.

Conventional communications networks that employ surge protectors and power devices that require the use of external surge protection devices have the disadvantage of requiring connections to a power sourcing equipment and to surge protectors in series at two separate devices. More specifically, the midspan PSE of the conventional communications network illustrated by FIG. 1 of the drawings includes no protector modules or surge protectors for either the data signals or the power signals provided to the powered end station. Any surge protectors used in such a conventional LAN communications system in a POE application are situated, if at all, outside the midspan PSE.

### OBJECTS AND SUMMARY OF THE INVENTION

It is an object of the present invention to provide a local area network (LAN) communications system having Power Over Ethernet (POE) capability that protects powered node devices from electrical surges and the like as well as the facilities and other equipment connected to the LAN communications system.

It is another object of the present invention to provide a midspan power sourcing equipment (PSE) that has integrated therewith over-voltage and over-current protection for both data signals and power signals either passing therethrough or generated thereby.

It is a further object of the present invention to provide an integrated surge protected midspan PSE that is compact in design and may be easily connected in a local area network (LAN) data and voice communications system.

It is yet a further object of the present invention to provide a surge protected LAN communications system having Power Over Ethernet (POE) capability that overcomes the inherent disadvantages of conventional LAN communications systems.

In accordance with one form of the present invention, a protected midspan power sourcing equipment (PSE) for a local area network (LAN) data and voice communications system includes a network connection subsystem, the network connection subsystem being connectable to at least one first network cable having a plurality of electrical wires. The midspan PSE further includes a powered equipment connection subsystem, the powered equipment connection subsystem being connectable to at least one second network cable having a plurality of electrical wires. The at least one second network cable being communicatable with a powered end station of the LAN communications system and providing at least one of power signals, power signals and voice signals and power signals and data signals to the powered end station.

The midspan PSE further includes a power source. The power source is connected to the powered equipment connection subsystem and being connectable to the at least one second network cable and generates the power signal providable on the at least one second network cable to the powered end station. The midspan PSE further includes electrical surge protectors. The electrical surge protectors are in communication with the powered equipment connection subsystem and the at least one second network cable, and provide electrical surge protection for the powered device which is powerable by the midspan PSE and which is connectable to the at least one second network cable.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is diagrammatic block diagram of a portion of a conventional local area network communications system incorporating a midspan power sourcing equipment.

FIG. 2 is a diagrammatic block diagram of a portion of a local area network communications system incorporating a midspan power sourcing equipment formed in accordance with the present invention.

FIG. 3 is a diagrammatic block diagram of a midspan power sourcing equipment for a local area network communications system formed in accordance with the present invention.

FIG. 4 is a diagrammatic block diagram of a midspan power sourcing equipment for a local area network communications system constructed in accordance with an alternative form of the present invention.

FIG. 5A is a diagrammatic block diagram of a first form of a protector module of the midspan power sourcing equipment of the present invention.

FIG. 5B is a diagrammatic block diagram of a second form of a protector module of the midspan power sourcing equipment of the present invention.

FIG. 5C is a diagrammatic block diagram of a third form of a protector module of the midspan power sourcing equipment of the present invention.

FIG. 6 is a simplified front isometric view of a protected midspan power sourcing equipment for a local area network communications system formed in accordance with the present invention.

FIG. 7 is a simplified rear isometric view of a protected midspan power sourcing equipment for a local area network communications system formed in accordance with the present invention, with the rear cover of the housing removed to show the internal components of the protected midspan power sourcing equipment.

FIG. 8 is a front view of the protected midspan power sourcing equipment of the present invention shown in FIGS. 6 and 7.

FIG. 9 is a rear view of the protected midspan power sourcing equipment of the present invention shown in FIGS. 6 and 7, with the rear cover of the housing removed to show the internal components of the protected midspan power sourcing equipment.

FIG. 10 is a side view of the protected midspan power sourcing equipment of the present invention shown in FIGS. 6 and 7.

FIG. 11 is a top view of the protected midspan power sourcing equipment of the present invention shown in FIGS. 6 and 7.

FIG. 12 is a transverse cross-sectional view of the protected midspan power sourcing equipment of the present invention shown in FIGS. 6 and 7, taken along line 12-12 of FIG. 8.

FIG. 13 is a longitudinal cross-sectional view of the protected midspan power sourcing equipment of the present invention shown in FIGS. 6 and 7, taken along line 13-13 of FIG. 8.

FIG. 14 is a schematic diagram of a protection circuit which may be used as a surge protector in the protected midspan power sourcing equipment of the present invention.

### DETAILED DESCRIPTION OF THE PREFERRED EMBODIMENTS

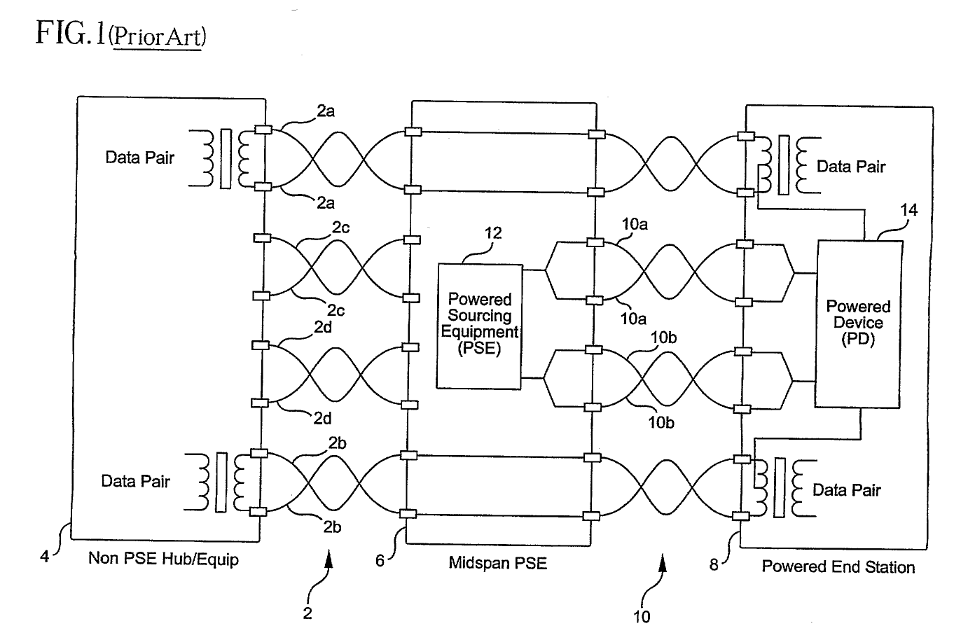

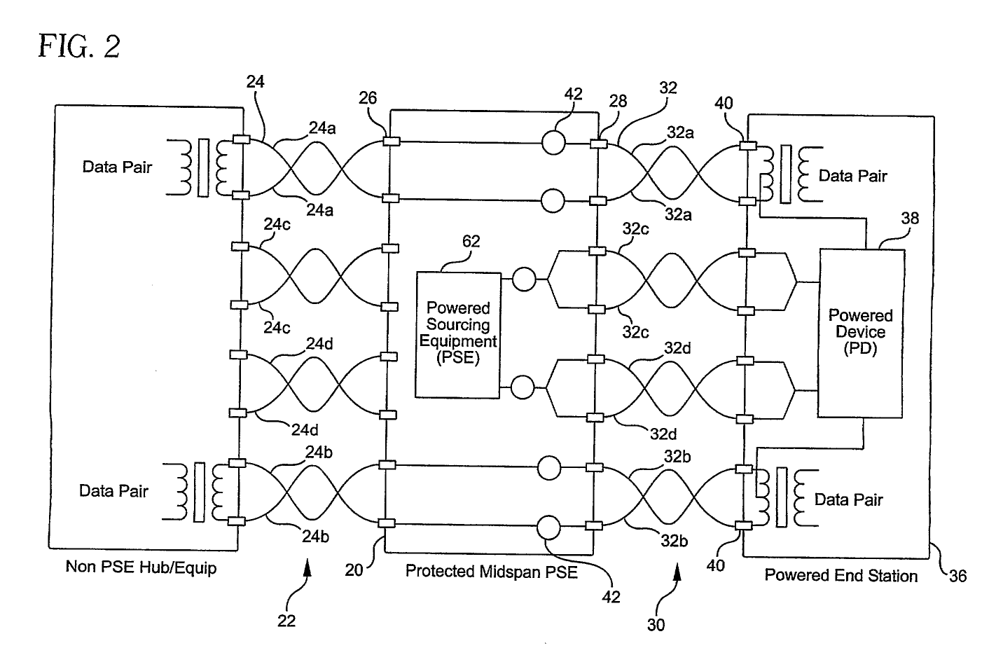

Referring initially to FIG. 2 of the drawings, it will be seen that a midspan power sourcing equipment (PSE) 20 for a local area network (LAN) communications system is connected in the same manner as described with the conventional system shown in FIG. 1. More specifically, one or more first cables 22, each carrying typically four twisted pairs of copper wire 24 under a single covering jacket, are connected to the midspan PSE 20 on the terminals 26 of a first input connector thereof. Preferably, two twisted pairs of wires 24a, 24b are provided to the midspan PSE 20 carrying data or voice signals. The other two twisted pairs of wires 24c, 24d are connected but not used, and carry no signals.

The terminals 28 of an output connector of the protected midspan PSE 20 of the present invention are connected to one or more second network cables 30, again each typically carrying four twisted pairs of wires 32 under one covering jacket. Two of the twisted pairs 32a, 32b of wires are used to provide the data or voice signals that were provided to the midspan PSE 20 from the hub or other equipment 34 of the LAN communications system. One or two other twisted pairs of wires 32c, 32d in the second network cable 30 are used to provide a power signal to a powered end station 36 and, in particular, a powered device (PD) 38 of the powered end station 36. Again, the powered end station 36 may be a web camera, an IP telephone, a facsimile machine, a computer, or any other type of equipment that is associated with a data or voice communications system and that is connected to the system at one of its nodes. One of the twisted pairs of electrical wires 32c, 32d cam also provide a return power signal path (e.g., ground) between the powered end station 36 and the protected midspan PSE 20. The second cable 30 is connected to the terminals 40 of a connector on the powered end station 36 and, as mentioned previously, to the terminals 28 on the output connector of the protected midspan PSE 20.

It should be noted here that the protected midspan PSE 20 of the present invention differs from the conventional midspan PSE 6 of the LAN communications system shown in FIG. 1 by including surge protectors 42 or others forms of over-voltage and/or over-current limiting devices, on the midspan PSE 20 and connected to preferably both the data and/or voice twisted pairs of electrical wires 32a, 32b and the power and return twisted pairs of electrical wires 32c, 32d. Thus, the protected midspan PSE 20 of the present invention not only provides Power Over Ethernet (POE) features, in order to provide power to a nodal device of the LAN communications system, but also protects preferably each data, voice and power line from one or both of over-voltage and over-current conditions, such as surge protection from lightning strikes or crossed power/data or voice communications lines that could damage the equipment connected to the LAN communications system. Thus, the LAN communications system, incorporating the protected midspan PSE 20 of the present invention, not only complies with IEEE Standard 802.3 (a)(f), but also Underwriters Laboratories' Standard UL 497, 497A and 497B.

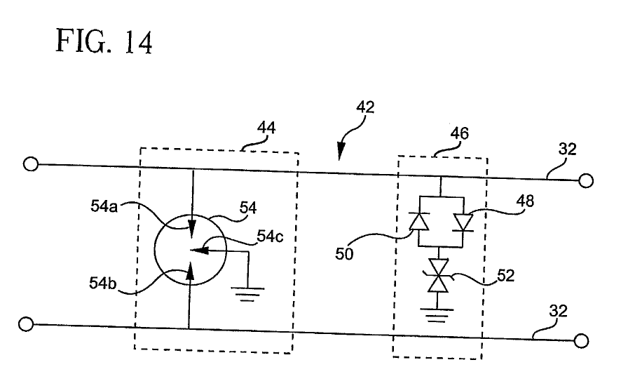

The protected midspan PSE 20 of the present invention may include any one of a number of different types of surge protectors 42. One such surge protector 42 is described in U.S. Pat. No. 4,535,379, which issued to Paul De Luca et al., the disclosure of which is incorporated herein by reference. Another such surge protector 42 for high speed data transmission is described in U.S. Pat. No. 6,421,220, which issued to Peter Kobsa, the disclosure of which is incorporated herein by reference. That particular surge protector disclosed in the Kobsa patent is illustrated in FIG. 14 of the drawings.

More specifically, the Kobsa surge protector which may be used in the protected midspan PSE of the present invention will now be described in greater detail. The surge protector includes an energy dissipating device 44 and a clamping circuit 46. The clamping circuit 46 has a pair of low capacitance, fast recovery diodes 48, 50 which are connected in parallel and in opposite polarity to each other. The parallel arrangement of diodes 48, 50 is connected to one wire of a twisted pair of electrical wires 32. The clamping circuit 46 further includes a bi-directional avalanche semiconductor 52, such as a TVS, which is connected between the parallel arrangement of diodes 48, 50 and ground. The energy dissipating device 44 preferably includes a gas dissipating tube 54. Gas dissipating tube 54 includes a first electrode 54a connected to one electrical wire of the twisted pair of wires 32, a second electrode 54b connected to the other electrical wire of the twisted pair of wires 32, and a third electrode 54c connected to ground. Ground may be a ground line or a ground tie point.

The surge protector 42 suppresses energy on the electrical wires 32 of the twisted pair in the following manner. Assume an energy surge occurs on either electrical wire 32 of the twisted pair. As the voltage of the transient energy surge begins to increase, the avalanche semiconductor 52 will reach its breakdown voltage, causing the transient to be clamped at the breakdown voltage within nanoseconds. The breakdown voltage will be at a safe level for the powered end station 36 connected at a node of the LAN communications system. The slower gas tube 54 will then have time to react to the energy surge and discharge the transient before the elements of the clamping circuit 46 or the powered end station equipment are damaged. The purpose of connecting the parallel arrangement of diodes 48, 50 in series with avalanche semiconductor 52 is to reduce the overall capacitance of the surge protector 42 between the electrical wires 32 of the twisted pair and ground, yet still provide the electronic equipment of the powered end station 36 connected to the twisted pairs of wires in the second network cable 30 with surge protection which includes the high current shunting capability of the gas discharge tube 54 and the fast reaction time to transients afforded by the avalanche semiconductor 52.

Again, the circuit shown in FIG. 14 of the drawings is but one example of many different types of surge protectors 42 which may be use in the protected midspan PSE 20 of the present invention, and it should be understood that the invention is not limited to any particular surge protector.

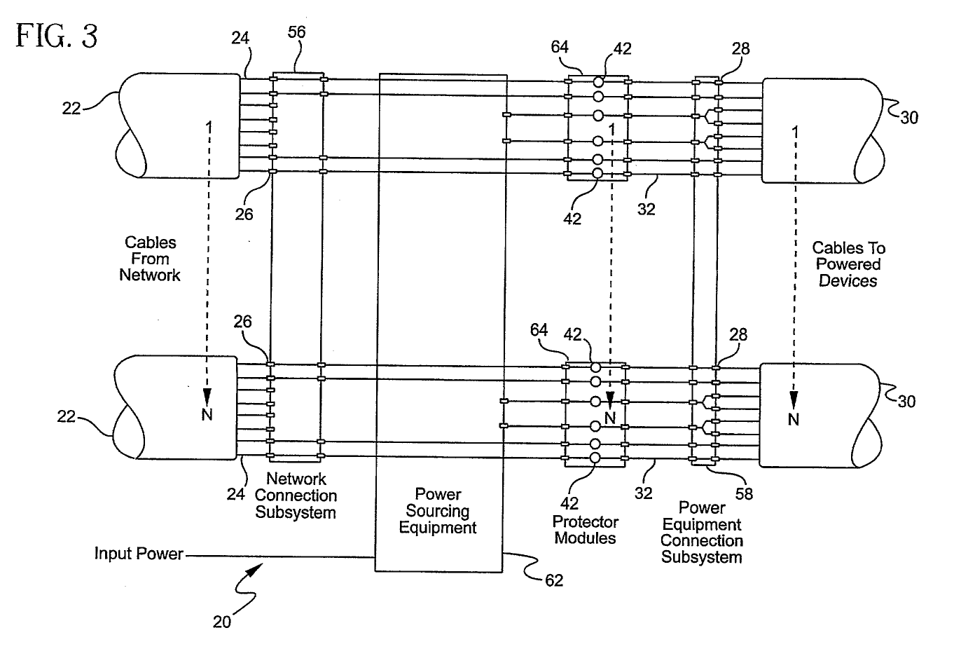

FIG. 3 illustrates a protected midspan PSE 20 formed in accordance with the present invention for use in a LAN communications network. Cables 22 from the LAN network, with each cable 22 typically carrying four twisted pairs of electrical wires 24, are provided to a network connection subsystem 56 of the protected midspan PSE 20 of the present invention. The network connection subsystem 56 basically provides an interface for connecting the various electrical wires 24 of the network cables 22 to the midspan PSE 20. The network connection subsystem 56 may be a connector block having wire wrap pins, screw terminals or insulation displacement connectors (IDC's) as input terminals 26, for example, for connecting the individual electrical wires 24 of the network cables 22 thereto. The network connection subsystem 56 thus generally includes a first connector with input terminals 26 for connecting the first network cables 22 (1 through N, where N is an integer), and selected terminals 26 will be connected electrically by wires, printed circuit lands or other means to a powered equipment connection subsystem 58.

The powered equipment connection subsystem 58 may also be in the form of a second connector block, which has output terminals 28 that may be in the form of wire wrap pins, screw terminals or IDC's, but more preferably is in the form of RJ45 connector jacks 60, to which are connected the electrical wires 32 of the twisted pairs of wires of the network cables 30 (1 through N) that are provided to one or more powered devices 38 of the LAN communications system.

It should be understood that the particular type of connectors used in the network connection subsystem 56 and the powered equipment connection subsystem 58 may be selected based upon the particular type of application in which the protected midspan PSE 20 of the present invention is envisioned to be used, and the direction of protection in the LAN system, and additionally, the particular protection circuit used in the protector modules 64 may be selected to provide surge protection to either or both sides of the LAN communications system connected to the protected midspan PSE.

As can be seen from FIG. 3 of the drawings, one or more of the network cables 30 that are provided to the powered device 38 (i.e., the powered end station 36) of the LAN communications system includes twisted pairs of wires 32, again typically four twisted pairs of wires per cable, that carry a power signal, a power signal and voice signal, or a power signal and a data signal to the powered end station 36 and in particular the powered device 38 thereof.

As further can be seen from FIGS. 2 and 3 of the drawings, certain of the wires 24a, 24b of each network cable 22 provided to the network connection subsystem 56 are electrically connected through the network connection subsystem and powered equipment connection subsystem 58 to the wires 32a, 32b of the network cables 30 connected to the powered devices 38 at the end stations 36 connected to the system at the LAN nodes. These wires carry voice and/or data signals through the protected midspan PSE 20 of the present invention.

The protected midspan PSE 20 also includes a power sourcing equipment 62, or power supply, that provides power to certain of the twisted pairs of electrical wires 32c, 32d of one or more of the network cables 30 provided to the powered devices 38 of the powered end station 36 of the LAN communications system. The power sourcing equipment (PSE) 62 in the preferred embodiment includes a power supply subsystem which is commercially available and which may be configured as shown in the aforementioned Lehr et al. patent (U.S. Pat. No. 6,473,608), the disclosure of which is incorporated herein by reference. Thus, in a preferred form, the powered sourcing equipment 62 provides a power signal on one or more twisted pairs of electrical wires 32c provided to the powered end station 36 and in particular the powered device 38 thereof. On one or more other twisted pairs of electrical wires 32d, a return power signal path, such as ground, is provided between the powered end station 36 and the power sourcing equipment 62 of the protected midspan PSE 20 of the present invention.

Again referring to FIG. 3 of the drawings, it will be seen that a protected midspan PSE 20 formed in accordance with the present invention includes one or more protector modules 64, each incorporating a surge protector 42 for one or both electrical wires 32 of each twisted pair of electrical wires of the network cables 30 routed to the powered devices 38 at the end stations 36. As mentioned previously, the surge protectors 42 of the protector modules 64 may be formed from any one of a number of protection circuits, such as the low capacitance surge protector described in the aforementioned Kobsa patent (U.S. Pat. No. 6,421,220). Thus, the protected midspan PSE 20 adds surge protection not only to the voice and data signals passing therethrough from the input network cables 22 of the LAN communications system to the output network cables 30 routed to the nodal powered end stations 36, but also preferably provides over-voltage and/or over-current protection with respect to the power signals provided by the power sourcing equipment 62 to the powered devices 38 of the end stations.

In summary, the present invention adds surge protection to the power and signal lines of a conventional midspan PSE in a link section of a LAN communications system. The protected midspan PSE 20 provides a connection point for the link cables emanating from the network. Certain twisted pairs of wires 24a, 24b carrying voice signals or data signals are connected directly to the surge protectors 42 of protector modules 64. Other twisted pairs of wires 24c, 24d which do not carry signals are terminated within the network connection subassembly 56. The power sourcing equipment (PSE) 62 receives power from a source and injects that power into the protector modules 64. The power and signal twisted pairs of electrical wires 32 are connected to the protector modules 64.

The over-current and over-voltage suppression elements contained within the surge protectors 42 of the protector modules 64 protect each signal and power path that will connect to the powered equipment. The over-current and over-voltage suppression circuits can be any protection circuit that is known in the art of telecommunications circuit protection, and balanced protection may be used on the twisted pair signal wires.

The powered equipment connection subsystem 58 of the protected midspan PSE 20 of the present invention provides a connection point between the link to the powered equipment and the protector modules 64. As shown in FIG. 3 of the drawings, in a preferred embodiment of the invention, the electrical wires of each twisted pair of electrical wires 32c, 32d used for the supply of power and the power return are connected together within the powered equipment connection subsystem 58. A fusable link (not shown) may be inserted between the powered equipment connection subsystem 58 and the protector modules 64.

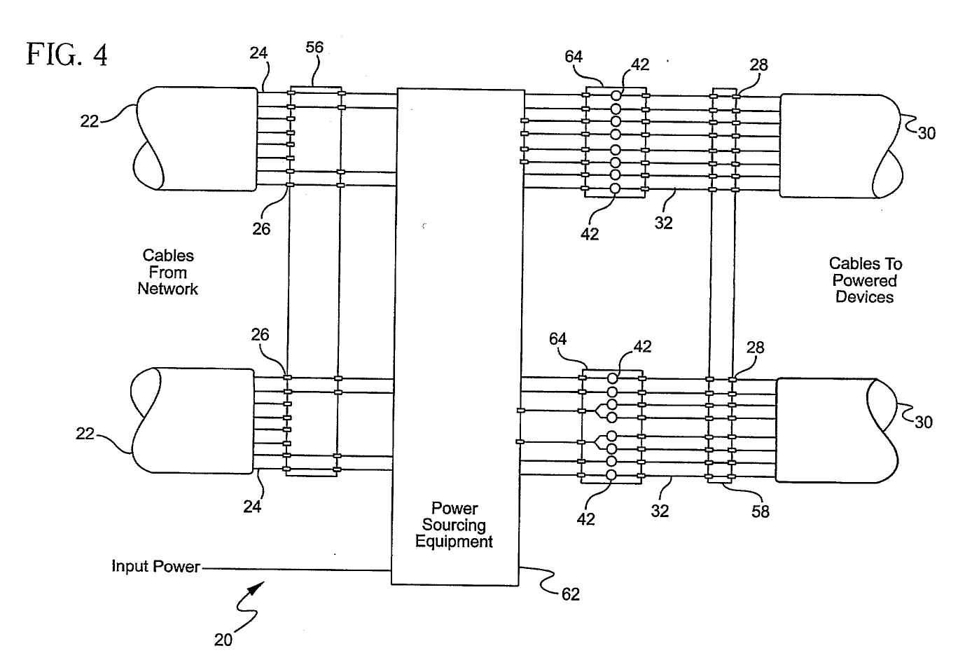

FIG. 4 illustrates a slight modification of the protected midspan PSE 20 of the present invention shown in FIG. 3. Here, the electrical wires of each twisted pair of electrical wires 32c, 32d used for the supply of power and the return are connected together either within the PSE 62 or within the protector module 64 associated with a particular network cable 30.

It should be realized that each protector module 64 includes a plurality of surge protectors 42 that are connected to individual electrical wires of the twisted pairs of wires 32 associated with one of the network cables 30, or connected to a single twisted pair of electrical wires 32 which are connected together, such as when a power signal or a return path is provided between the powered equipment connection subsystem 58 and the power sourcing equipment (PSE) 62.

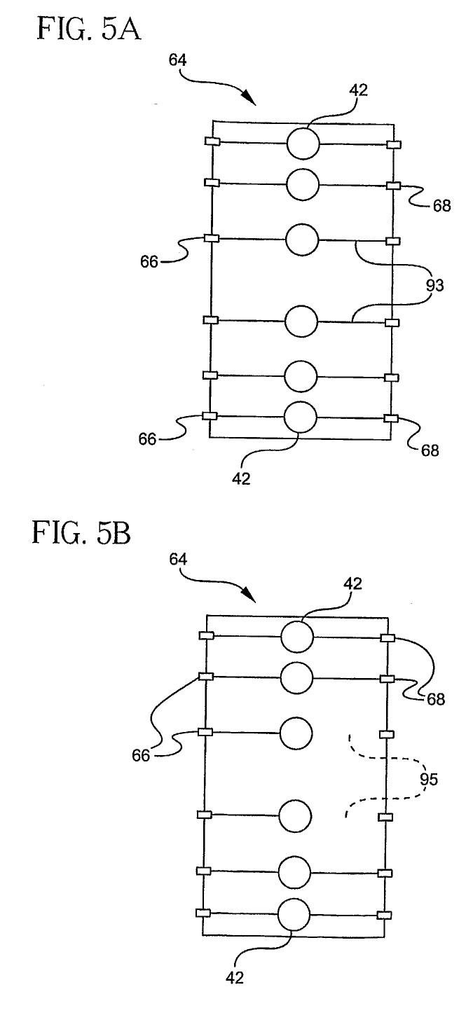

Each of FIGS. 5A, 5B and 5C illustrates in block diagram form a typical protector module 64. Again, each protector module 64 includes a plurality of protection circuits 42. The modules 64 may include input terminals 66 for connecting the individual protection circuits 42 to the power sourcing equipment 62 and/or the network connection subsystem 56 (and at least certain of the twisted pairs of wires 24 of the input cables 22 that are connected thereto), and a plurality of output terminals 68 for connecting the protection circuits 42 to the powered equipment connection subsystem 58 and the twisted pairs of wires 32 of the output network cables 30 that are connected thereto. As stated previously, over-current and over-voltage suppression elements are contained within the protector modules 64 to protect each path that will connect to the powered equipment at the end station 36. The over-current and over-voltage suppression circuits can be any protection circuit that is known in the art of telecommunication or data circuit protection, such as that disclosed in the aforementioned Kobsa patent (U.S. Pat. No. 6,421,220). Balanced protection may be used on the twisted pair signal wires 32a, 32b, and the protection circuits 42 may either open the link or short the link between the powered equipment and earth ground. In addition, it should be understood that each protector module 64 may include different types of protection circuits 42 depending upon whether the protection circuit is used to protect data and/or voice signal lines or power and return signal lines.

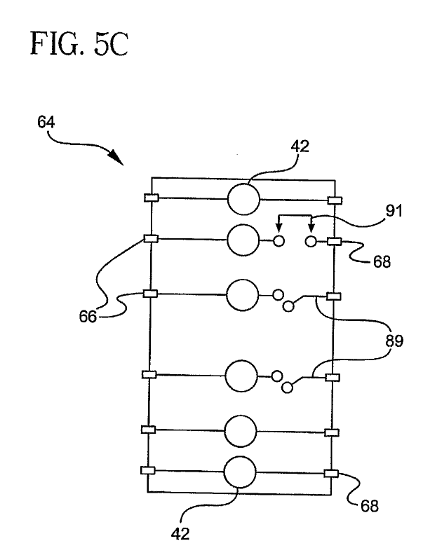

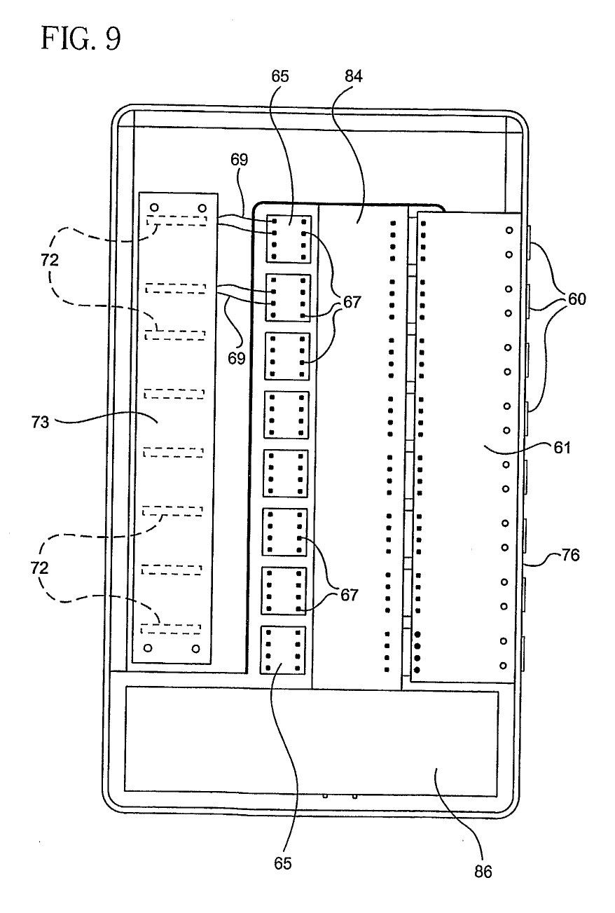

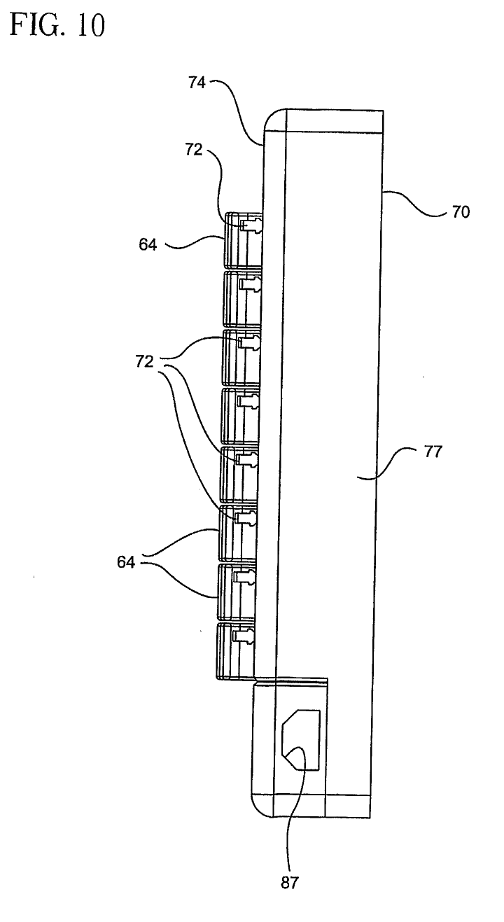

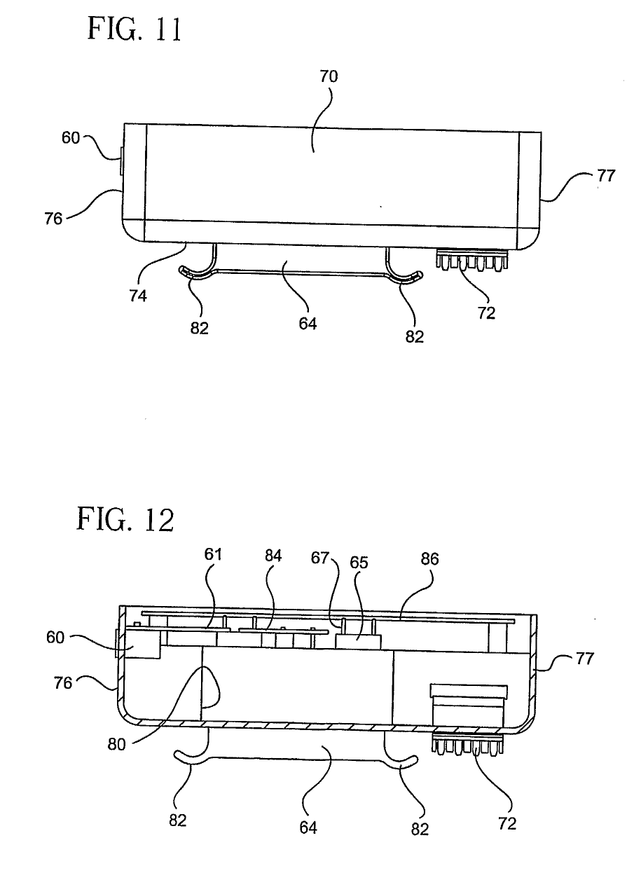

FIGS. 6-13 illustrate a physical configuration of a protected midspan PSE 20 formed in accordance with the present invention. The protected midspan PSE 20 includes a rectangular, box-like housing 70 defining an interior space for receiving the network connection subsystem 56, the power sourcing equipment 62, the protector modules 64 and the powered equipment connection subsystem 58.

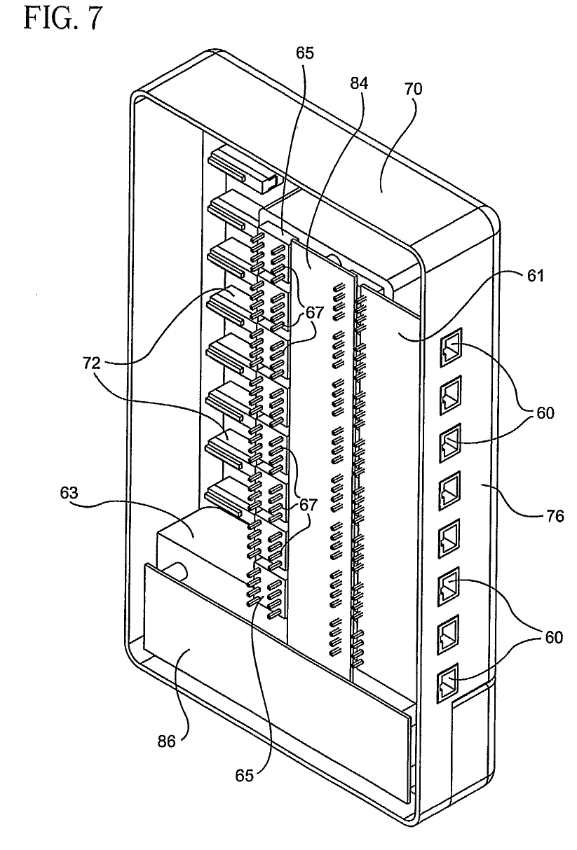

More specifically, the protected midspan PSE 20 of the present invention preferably includes a network connection subsystem 56 formed as a block of eight rows of punch down insulation displacement connectors (IDC's) 72 exposed on the front face 74 of the housing 70. The IDC's 72 are provided for connecting the protected midspan PSE 20 to up to eight input network cables 22, each containing four twisted pairs of electrical wires 24. The IDC's 72 are mounted on a mounting plate 73 inside the housing 70, as shown in FIG. 8. The IDC's 72 are preferably 110 style connectors.

The protected midspan PSE 20 also includes a powered equipment connection subsystem 58. In the embodiment of the protected midspan PSE shown in FIGS. 6-13, the powered equipment connection subsystem 58 is formed as a block of eight spaced apart RJ45 connector jacks 60 situated in a column on a lateral side 76 of the housing 70. Each RJ45 connector jack 60 can receive and electrically mate with a comparable RJ45 connector plug situated on the end of an output network cable 30 that is connected to a powered end station 36. The RJ45 connector jacks 60 are wired internally in the midspan PSE housing 70 to a plurality of protector modules 64, a power source 62 situated within the housing 70, ground and certain of the IDC's 72 of the network connection subsystem 56 that carry voice or data signals. The RJ45 connector jacks are mounted to a printed circuit interface board 61 within the housing 70, as shown in FIG. 8.

The plurality of protector modules 64, one module for each output network cable 30, is situated on the front face 74 of the housing, with each module 64 being accessible by a technician. Each module 64 has a housing 78 that contains internally enough protection circuits 42 (preferably three to four or six to eight) to handle a pair of wires or individual wires of the four twisted pairs of electrical wires 32 found in each network cable 30. The protector modules 64 are removably secured to and received by a single recess or separate recesses 80 formed in the front face 74 of the midspan PSE housing 70 by resilient clips (not shown) situated on either the midspan PSE 70 housing or on the module housings 78 that cooperate with exposed edges (not shown) of the other of the midspan PSE housing 70 or the protector module housings 78. Each protector module 64 may include handles 82 situated on the lateral sides of the module housings 78 to facilitate the removal and insertion of the protector modules 64 from and into recesses 80 of the protected midspan PSE 20. The protector modules 64 have exposed contacts which electrically engage exposed contacts of the midspan PSE 20 that are connected to the electrical wires of the twisted pairs of wires 32 of each output network cable 30 to provide surge protection to each wire and to the nodal equipment of the LAN communications system to which the wires are connected.

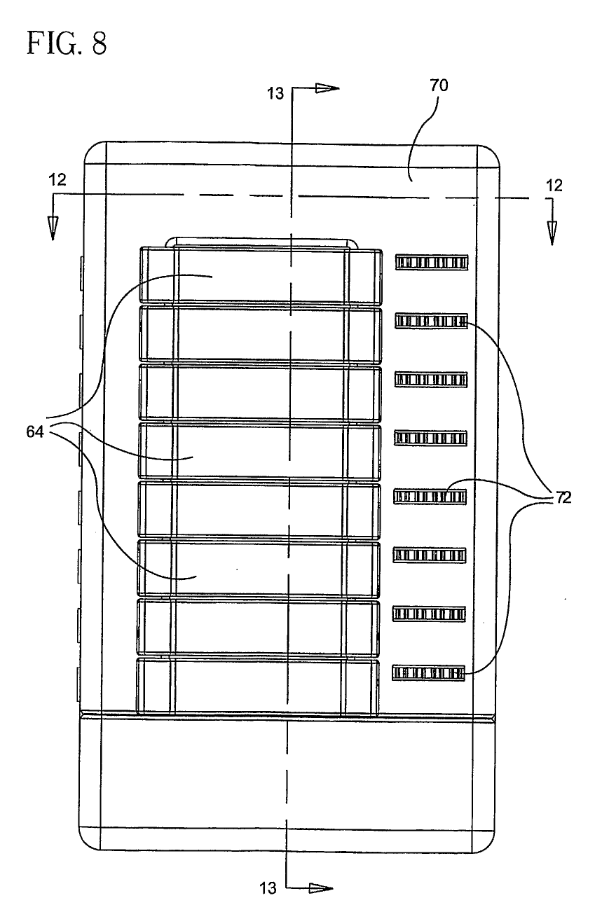

Even more specifically, the electrical contacts of the protector modules 64 engage contacts (not shown) on one side of respective sockets 65 seated at the bottom of recess or recesses 80. The opposite side of each socket 65 includes a plurality of wire-wrap pins 67, which are connected to the IDC's 72 by wires 69, only some of which are shown in FIG. 9 for illustrative purposes.

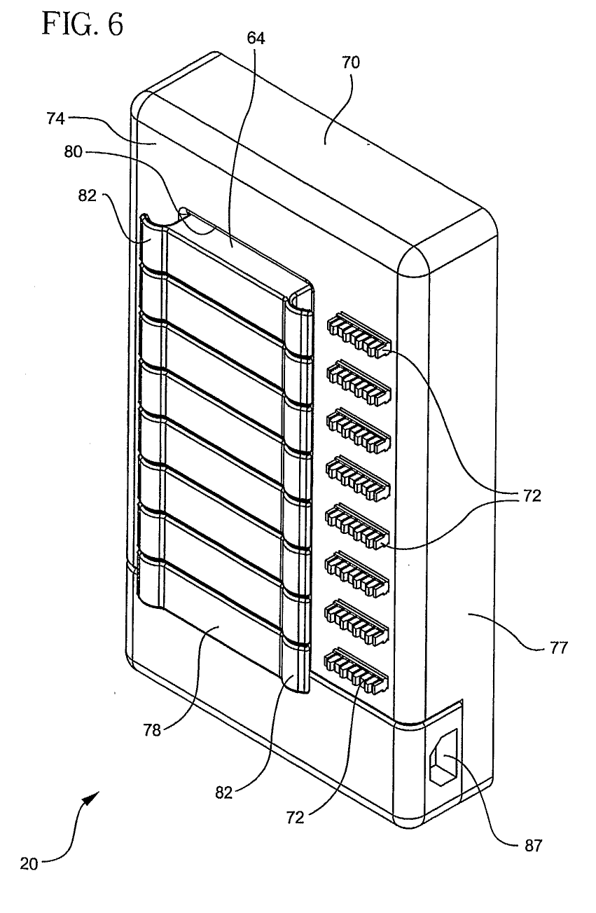

The protected midspan PSE 20 of the present invention may further include a power source 62, such as the power supply disclosed in the aforementioned Lehr et al. patent (U.S. Pat. No. 6,473,608), which provides power to selected electrical wires 32c, 32d of the twisted pairs of wires of the output network cables 30 to provide POE power (and a return path) to a powered device 38 (e.g., web camera, IP phone or the like) situated at a powered end station 36 of the LAN communications system. Even more preferably, the protected midspan PSE 20 includes a power management distribution unit 84 that selectively provides power to equipment connected to the midspan PSE 20 through an output network cable 30 connected to one of the eight RJ45 connector jacks 60, and a control unit 86 (shown as a printed circuit board in FIG. 7) which includes circuitry connected to the power management distribution unit 84 and which controls the power management distribution unit in its selective supply of power to the RJ45 connector jacks 60 of the powered equipment connector subsystem 58 and the output network cables 30 connected thereto. Power is supplied to the power management distribution unit 84 from an external power source (not shown) through an appropriate connector 87 mounted on a lateral side 77 of the housing 70. A suitable power management distribution unit 84 and control logic 86 therefor for use in the protected midspan PSE 20 of the present invention is described in the aforementioned U.S. Pat. No. 6,473,608, which issued to Amir Lehr et al., the disclosure of which is incorporated herein by reference. Alternatively, a manual switch 89 or jumper wire circuit 91 may be used in lieu of the control logic circuit 86 and/or the power management distribution unit 84 to manually direct power to a particular powered device 14 connected to the protected midspan PSE 20. The switch 89 or jumper wire circuit 91 may be a separate circuit situated within the midspan PSE 20, or may be situated within the protector modules 64 connected to the midspan PSE, as shown in FIG. 5C. Furthermore, it may be advantageous and is within the scope of the present invention to color code the protector modules received by the midspan PSE (or use some other form of identifier, such as tape, numbers, indicia, or the like situated on or near the modules 64) so that a technician may easily identify and select different protector modules for use in the midspan PSE, for example, such as where a protector module 64 of one color has a circuit connection 93 incorporated therein which connects power to a powered device from the midspan PS, such as shown in FIG. 5A, and a protector module 64 of a different color has no connection for power to be provided to a nodal device, such as shown in FIG. 5B at reference number 95 therein.

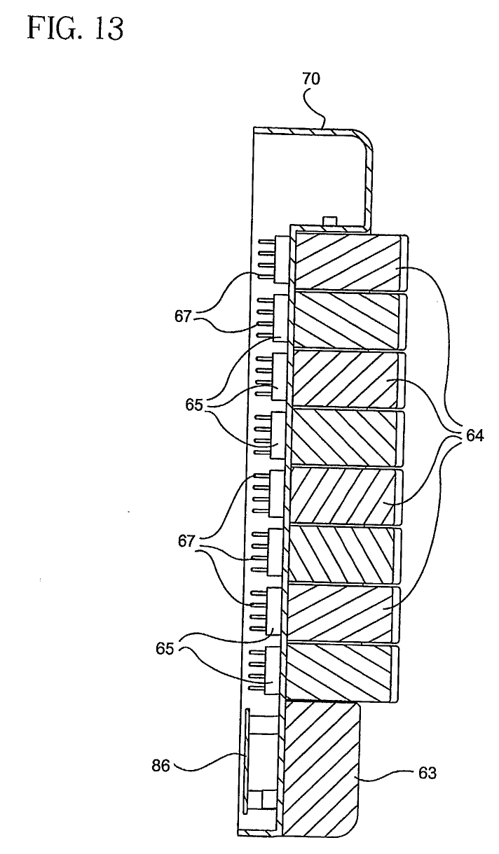

The external power source may include, for example, a wall mount transformer to provide the proper voltage for operating the power management distribution unit 84 and the control logic 86 of the protected midspan PSE 20 of the present invention, and to provide the required voltage to the powered device 38 on the LAN communications system. Alternatively, a power supply circuit, depicted generally in FIGS. 7 and 13 by block 63, including a transformer if necessary, may be included with the protected midspan PSE 20 of the present invention.

It should be understood that, although eight rows of IDC's 72, eight RJ45 connector jacks 60 and six to eight protection circuits 42 in each protector module 64 are disclosed herein, it is envisioned to be within the scope of the present invention to provide the protected midspan PSE 20 of the present invention with any number and type of input network cable connectors, output network cable connectors, protector modules and protection circuits.

The protected midspan PSE 20 of the present invention provides protection in a link section of a LAN communications system for both power and signal lines. Over-current and over-voltage suppression elements are contained within the protector modules 64 situated in the midspan PSE to protect each path that will connect to the powered equipment. With the present invention, there is no need to have separate connections to the PSE and separate connections to surge protectors; with the present invention, both power and data/voice signal lines provided to equipment powered using POE will be protected.

It should also be noted that the protected midspan PSE 20 of the present invention can function as different components in the overall local area network communications system, and form part of a building entrance terminal (BET), a main distribution frame (MDF), an intermediate distribution frame (IDF) and a hand-over distribution frame (HDF) found in a typical LAN communications system.

It should be further realized that the power signal provided by the PSE 62 need not be provided to the powered end station 36 on a separate twisted pair of electrical wires; rather, the PSE may provide the power signal superimposed on the data and/or voice signals on a single twisted pair of wires.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A protected midspan power sourcing equipment (PSE) for a local area network (LAN) communications system, which comprises:
a network connection subsystem, the network connection subsystem being connectable to at least one first network cable having a plurality of electrical wires;
a powered equipment connection subsystem, the powered equipment connection subsystem being connectable to at least one second network cable having a plurality of electrical wires, the at least one second network cable being communicatable with a powered end station of the LAN communications system and providing at least one of a power signal, a power signal and a voice signal and a power signal and a data signal to the powered end station;
a power source, the power source being connected to the powered equipment connection subsystem and being connectable to the at least one second network cable and generating the power signal providable on the at least one second network cable to the powered end station; and
electrical surge protectors, the electrical surge protectors being in communication with the powered equipment connection subsystem and the at least one second network cable and providing electrical surge protection for the powered device which is powerable by the midspan PSE and which is connectable to the at least one second network cable.

2. A protected midspan PSE as defined by claim 1, wherein the at least one second network cable includes a first pair of wires and a second pair of wires, the first and second pairs of wires being connectable to the powered equipment connection subsystem; wherein the power source generates a power signal providable to each electrical wire of the first pair of electrical wires of the at least one second network cable; and wherein each of the electrical wires of the second pair of electrical wires of the at least one second network cable defines a return power signal path.

3. A protected midspan PSE as defined by claim 2, wherein the powered equipment connection system electrically connects together each electrical wire of the first pair of electrical wires of the at least one second network cable on which the power signal from the power source is providable; and wherein the power equipment connection system electrically connects together each electrical wire of the second pair of electrical wires of the at least one second network cable which defines the return power signal path.

4. A protected midspan PSE as defined by claim 2, wherein the electrical surge protectors include a first surge protector and a second surge protector, the first surge protector electrically connecting together each electrical wire of the first pair of electrical wires of the at least one second network cable on which the power signal from the power source is providable, the second surge protector electrically connecting together each electrical wire of the second pair of electrical wires of the at least one second network cable which defines the return power signal path.

5. A protected midspan PSE as defined by claim 1, wherein each of the surge protectors provides at least one of over-current and over-voltage protection to the powered end station connectable to the powered equipment connection subsystem.

6. A protected midspan PSE as defined by claim 1, wherein the LAN communications system includes a building entrance terminal (BET), and wherein the surge protectors form a portion of the BET.

7. A protected midspan PSE as defined by claim 1, wherein the LAN communications system includes a frame block, and wherein the surge protectors form a portion of the frame block.

8. A protected midspan PSE as defined by claim 7, wherein the frame block is at least one of a main distribution frame (MDF), an intermediate distribution frame (IDF) and a hand-over distribution frame (HDF).

9. A protected midspan PSE as defined by claim 1, wherein the power source provides the power signal superimposed on at least one of a data signal and a voice signal to the powered equipment connection subsystem and the at least one second network cable.

10. A protected midspan PSE as defined by claim 1, wherein the power source provides the power signal on at least a first electrical wire of the at least one second network cable, and wherein the at least one second network cable includes a second electrical wire on which is provided at least one of a voice signal and a data signal, the first electrical wire being different from the second electrical wire of the at least one second network cable.

11. A protected midspan PSE as defined by claim 1, which further comprises:
a power management distribution unit, the power management distribution unit selectively supplying power to at least one electrical wire of the at least one second network cable.

12. A protected midspan PSE as defined by claim 11, which further comprises:
a logic control circuit, the logic control circuit being operatively coupled to the power management distribution unit to control the selective supply of power to the at least one electrical wire of the at least one second network cable by the power management distribution unit.

13. A protected midspan PSE as defined by claim 1, which further comprises:
a housing; and
at least one protector module, the at least one protector module including at least one of the surge protectors, the at least one protector module being removably mounted on the housing of the protected midspan PSE.

14. A protected midspan PSE as defined by claim 13, wherein the at least one protector module includes at least one of a switch and a jumper circuit to selectively provide the power signal on at least one electrical wire of the at least one second network cable.

15. A protected midspan PSE as defined by claim 1, which further comprises:
a housing; and
a plurality of protector modules, each of the protector modules including at least one of the surge protectors, the protector modules being removably mounted on the housing of the protected midspan PSE.

16. A protected midspan PSE as defined by claim 15, wherein at least one of the protector modules has a first identifier associated therewith, and at least another of the protector modules has a second identifier associated therewith, the first identifier being different from the second identifier.

17. A protected midspan PSE as defined by claim 16, wherein the first identifier is a first color and the second identifier is a second color, and wherein the first color is different from the second color.

18. A protected midspan PSE as defined by claim 16, wherein the at least one second network cable includes a first, second network cable and a second, second network cable; wherein the at least one of the protector modules having the first identifier includes an electrical connection to at least one electrical wire of the first, second network cable; and wherein the at least another of the protector modules having the second identifier includes no electrical connection to at least one electrical wire of the second, second network cable.
